(19) United States
(12) Patent Application Publication
(10) Pub. No.: US 2022/0194186 A1
(43) Pub. Date: Jun. 23, 2022

(54) VANITY MIRROR

(71) Applicant: Daimay North America Automotive, Inc., Redford, MI (US)

(72) Inventor: Yintai Jiang, Shanghai (CN)

(21) Appl. No.: 17/606,081

(22) PCT Filed: Jun. 27, 2019
(86) PCT No.: PCT/CN2019/093292

§ 371 Date: Oct. 25, 2021

(51) Int. Cl. B60J 3/02

(52) U.S. Cl. CPC B60J 3/0282

(57) ABSTRACT

This disclosure relates to a vanity mirror for a vehicle, such as a motor vehicle. An example vanity mirror includes a layer of shatter resistant material, a layer of metallic plating attached directly to the layer of shatter resistant material, a layer of adhesive material, and a glass layer attached to the layer of metallic plating via the layer of adhesive material. The disclosed vanity mirror is relatively easy to manufacture and performs well even under extreme temperature conditions (i.e., as low as −40 and as high as 120° C.) without exhibiting deformations such as bumps, cracks, or other distortions.

### TECHNICAL FIELD

This disclosure relates to a vanity mirror for a vehicle, such as a motor vehicle.

### BACKGROUND

Some passenger motor vehicles include sun visors attached to a windshield or roof of a vehicle. Sun visors may be located adjacent the driver and passenger seat, for example, and protect the driver and passenger from bright sunlight. Some known sun visors pivot to a stowed position when not in use, and may include a light and/or a vanity mirror.

### SUMMARY

A vanity mirror according to an exemplary aspect of the present disclosure includes, among other things, a layer of shatter resistant material, a layer of metallic plating attached directly to the layer of shatter resistant material, a layer of adhesive material, and a glass layer attached to the layer of metallic plating via the layer of adhesive material.

In a further embodiment, the layer of shatter resistant material has a thickness within a range of 0.25-1.00 mm.

In a further embodiment, the layer of shatter resistant material has a Shore hardness within a range of 70-90.

In a further embodiment, the layer of shatter resistant material has a reflectivity of greater than 90%.

In a further embodiment, the layer of shatter resistant material is bonded to the glass layer by a bonding force within a range of 100-169 N/25 mm.

In a further embodiment, the layer of metallic material is provided by silver plating.

In a further embodiment, the silver plating includes a layer of metal silver and two layers of paint.

In a further embodiment, the silver plating has a thickness within a range of 40-50 μm.

In a further embodiment, the glass layer is provided by a layer of float glass.

In a further embodiment, the float glass has a thickness within a range of 1.9-2.1 mm.

In a further embodiment, the adhesive material is provided by double sided tape.

In a further embodiment, the double sided tape has a thickness of 0.01 mm.

In a further embodiment, a bonding force between the layer of adhesive material and the glass layer is greater than 8 N/25 mm.

In a further embodiment, a bonding force between the layer of adhesive material and the layer of shatter resistant material is greater than 8 N/25 mm.

A sun visor assembly for a motor vehicle according to an exemplary aspect of the present disclosure includes, among other things, a vanity mirror which itself includes a layer of shatter resistant material having thickness within a range of 0.25-1.00 mm, a Shore hardness within a range of 70-90, and a reflectivity of greater than 90%. The vanity mirror further includes a layer of silver plating attached directly to the layer of shatter resistant material. The layer of silver plating includes a layer of metal silver and two layers of paint, and has a thickness within a range of 40-50 μm. The vanity mirror further includes a layer of double sided tape having a thickness of 0.01 mm, and a layer of float glass attached to the layer of metallic plating via the layer of double sided tape. The layer of float glass has a thickness within a range of 1.9-2.1 mm. Further, the layer of shatter resistant material is bonded to the glass layer by a bonding force within a range of 100-169 N/25 mm, and a bonding force between the layer of adhesive material and the glass layer is greater than 8 N/25 mm and a bonding force between the layer of adhesive material and the layer of shatter resistant material is greater than 8 N/25 mm.

A method of making a vanity mirror according to an exemplary aspect of the present disclosure includes, among other things, attaching a layer of metallic material to a layer of shatter resistant material, and following the attaching step, using double sided tape to bond the combined layer of metallic material and layer of shatter resistant material to a glass layer.

In a further embodiment, the layer of shatter resistant material has a thickness within a range of 0.25-1 mm, a Shore hardness within a range of 70-90, and a reflectivity of greater than 90%.

In a further embodiment, the layer of shatter resistant material is bonded to the glass layer by a bonding force within a range of 100-169 N/25 mm.

In a further embodiment, the layer of metallic material is provided by silver plating including a layer of metal silver and two layers of paint, the silver plating has a thickness within a range of 40-50 μm, and the glass layer is provided by a layer of float glass having a thickness within a range of 1.9-2.1 mm.

In a further embodiment, the double sided tape has a thickness of 0.01 mm, a bonding force between the double sided tape and the glass layer is greater than 8 N/25 mm, and a bonding force between the double sided tape and the layer of shatter resistant material is greater than 8 N/25 mm.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 illustrates an example sun visor assembly.

FIG. 2 is a cross-sectional view of an exemplary vanity mirror.

### DETAILED DESCRIPTION

This disclosure relates to a vanity mirror for a vehicle, such as a motor vehicle. An example vanity mirror includes a layer of shatter resistant material, a layer of metallic plating applied directly to the layer of shatter resistant material, a layer of adhesive material, and a glass layer attached to the layer of metallic plating via the layer of adhesive material. The disclosed vanity mirror is relatively easy to manufacture and performs well even under extreme temperature conditions (i.e., as low as −40 and as high as 120° C.) without exhibiting deformations such as bumps, cracks, or other distortions.

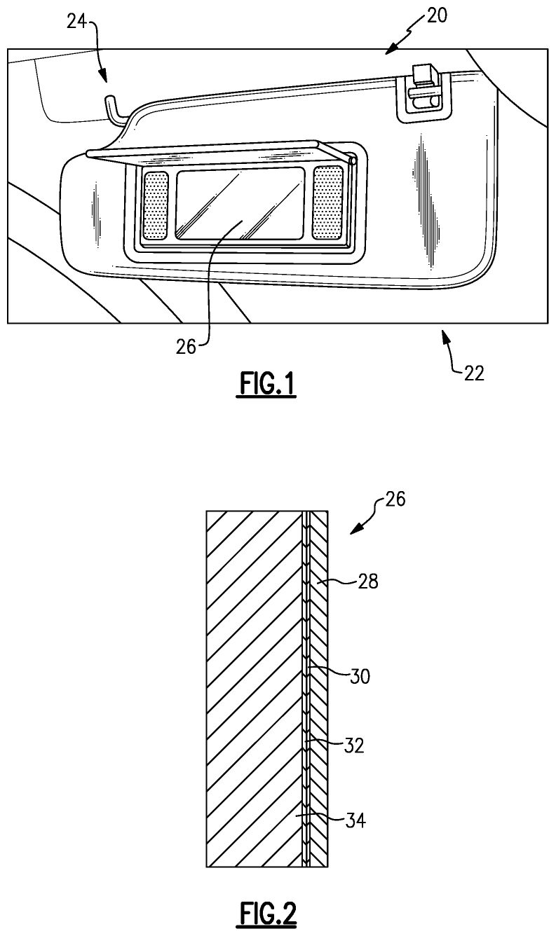

FIG. 1 illustrates an example sun visor assembly 20. In this example, the sun visor assembly 20 is mounted in a vehicle cabin 22 via a mount 24. The mount 24 may be attached to a corner of a windshield or roof of the vehicle cabin 22, for example. The sun visor assembly 20 may be mounted in the vehicle cabin 22 at the driver's side, passenger side, or both.

The sun visor assembly 20 includes a vanity mirror 26 in this example. Detail of the vanity mirror 26 will be described with reference to FIG. 2, which illustrates the vanity mirror 26 in cross-section.

The example vanity mirror 26 includes a layer of shatter resistant material 28. The shatter resistant material 28 is polycarbonate in one example. Further, in this example, the shatter resistant material 28 has thickness (i.e., in the left-to-right direction, relative to FIG. 2) within a range of 0.25-1.00 mm. The shatter resistant material 28 also has a Shore hardness within a range of 70-90, and a reflectivity of greater than 90%.

The vanity mirror 26 further includes a layer of metallic plating, which in one example is a layer of silver plating 30, applied directly to the layer of shatter resistant material 28. The layer of silver plating 30 includes a layer of metal silver and two layers of paint, in one example. In this example, the layer of silver plating 30 has a thickness within a range of 40-50 μm.

The vanity mirror 26 includes a layer of adhesive material 32, which may be double sided tape, having a thickness of 0.01 mm, in one example. The double sided tape is polyethylene terephthalate (PET) in one example.

The vanity mirror 26 also includes a layer of float glass 34 attached to the layer of shatter resistant material 28 via the layer of adhesive material 32. The layer of float glass 34 has a thickness within a range of 1.9-2.1 mm, and provides a base for the vanity mirror 26.

In the example of FIG. 2, the layer of shatter resistant material 28 is bonded to the layer of float glass 34 by a bonding force within a range of 100-169 N/25 mm. The units N/25 mm define a force required to separate two layers having widths of 25 mm. Further, a bonding force between the layer of adhesive material 32 and the layer of float glass 34 is greater than 8 N/25 mm and a bonding force between the layer of adhesive material 32 and the layer of shatter resistant material 28 is greater than 8 N/25 mm. The arrangement discussed above, including the material properties and dimensions discussed above, provides marked advantages over prior vanity mirrors, and in particular resists deformation even under extreme temperatures.

The vanity mirror 26 may be made, in one example, by applying the layer of silver plating 30 to a layer of shatter resistant material 28. Following that step, double sided tape may be used to bond the combined layer of silver material and shatter resistant material 28 to the layer of float glass 34. The disclosed vanity mirror is thus relatively easily manufactured.

It should be understood that terms such as “outside,” “forward,” “rearward,” “vertical,” and “horizontal” are used above with reference to the normal, upright position of a car seat in a vehicle. These terms have been used herein for purposes of explanation, and should not be considered otherwise limiting. Terms such as “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A vanity mirror, comprising:
a layer of shatter resistant material;
a layer of metallic plating attached directly to the layer of shatter resistant material;
a layer of adhesive material; and
a glass layer attached to the layer of metallic plating via the layer of adhesive material.

2. The vanity mirror as recited in claim 1, wherein the layer of shatter resistant material has a thickness within a range of 0.25-1.00 mm.

3. The vanity mirror as recited in claim 2, wherein the layer of shatter resistant material has a Shore hardness within a range of 70-90.

4. The vanity mirror as recited in claim 3, wherein the layer of shatter resistant material has a reflectivity of greater than 90%.

5. The vanity mirror as recited in claim 1, wherein the layer of shatter resistant material is bonded to the glass layer by a bonding force within a range of 100-169 N/25 mm.

6. The vanity mirror as recited in claim 1, wherein the layer of metallic material is provided by silver plating.

7. The vanity mirror as recited in claim 6, wherein the silver plating includes a layer of metal silver and two layers of paint.

8. The vanity mirror as recited in claim 6, wherein the silver plating has a thickness within a range of 40-50 μm.

9. The vanity mirror as recited in claim 1, wherein the glass layer is provided by a layer of float glass.

10. The vanity mirror as recited in claim 9, wherein the float glass has a thickness within a range of 1.9-2.1 mm.

11. The vanity mirror as recited in claim 1, wherein the adhesive material is provided by double sided tape.

12. The vanity mirror as recited in claim 11, wherein the double sided tape has a thickness of 0.01 mm.

13. The vanity mirror as recited in claim 11, wherein a bonding force between the layer of adhesive material and the glass layer is greater than 8 N/25 mm.

14. The vanity mirror as recited in claim 11, wherein a bonding force between the layer of adhesive material and the layer of shatter resistant material is greater than 8 N/25 mm.

15. A sun visor assembly for a motor vehicle, comprising
a vanity mirror, comprising:
a layer of shatter resistant material having thickness within a range of 0.25-1.00 mm, a Shore hardness within a range of 70-90, and a reflectivity of greater than 90%;
a layer of silver plating attached directly to the layer of shatter resistant material, the layer of silver plating including a layer of metal silver and two layers of paint, wherein the silver plating has a thickness within a range of 40-50 μm;
a layer of double sided tape having a thickness of 0.01 mm; and
a layer of float glass attached to the layer of metallic plating via the layer of double sided tape, the layer of float glass having a thickness within a range of 1.9-2.1 mm;
wherein the layer of shatter resistant material is bonded to the glass layer by a bonding force within a range of 100-169 N/25 mm; and
wherein a bonding force between the layer of adhesive material and the glass layer is greater than 8 N/25 mm and a bonding force between the layer of adhesive material and the layer of shatter resistant material is greater than 8 N/25 mm.

16. A method of making a vanity mirror, comprising:
attaching a layer of metallic material to a layer of shatter resistant material; and
following the attaching step, using double sided tape to bond the combined layer of metallic material and layer of shatter resistant material to a glass layer.

17. The method as recited in claim 16, wherein the layer of shatter resistant material has a thickness within a range of 0.25-1 mm, a Shore hardness within a range of 70-90, and a reflectivity of greater than 90%.

18. The method as recited in claim 17, wherein the layer of shatter resistant material is bonded to the glass layer by a bonding force within a range of 100-169 N/25 mm.

19. The method as recited in claim 18, wherein:
the layer of metallic material is provided by silver plating including a layer of metal silver and two layers of paint,
the silver plating has a thickness within a range of 40-50 μm, and
the glass layer is provided by a layer of float glass having a thickness within a range of 1.9-2.1 mm.

20. The method as recited in claim 19, wherein:
the double sided tape has a thickness of 0.01 mm,
a bonding force between the double sided tape and the glass layer is greater than 8 N/25 mm, and
a bonding force between the double sided tape and the layer of shatter resistant material is greater than 8 N/25 mm.
